(19) United States
(12) Patent Application Publication
(10) Pub. No.: US 2007/0024850 A1
(43) Pub. Date: Feb. 1, 2007

(54) Complete system identification of film-substrate systems using single-angle-of-incidence ellipsometry: A fast genetic algorithm

(76) Inventors: AR M Zaghloul, Pooler, GA (US); Yasser A. Zaghloul, Pooler, GA (US)

Correspondence Address: YASSER A. ZAGHLOUL, 2926 OSPREY POINT CIRCLE, POOLER, GA, 31322, US

(21) Appl. No.: 11/457,752

(22) Filed: Jul. 14, 2006

Related U.S. Application Data
(60) Provisional application No. 60/595,687, filed on Jul. 27, 2005.

(51) Int. Cl. G01J 4/00

(52) U.S. Cl. 356/369

(57) ABSTRACT

A method to dynamically and completely identify in real-time a transparent-film absorbing-substrate system: determine the film thickness and optical constant and the substrate optical constant, using any ellipsometer to measure only one pair of the two ellipsometric angles psi and del at only one angle of incidence and at only one wavelength, and a fast optimized genetic algorithm which employs a fitness function based on a physical condition along with an optimization method are provided. With proper modification the provided optimized genetic algorithm, and the provided optimization method, are used to fully characterize absorbing-film absorbing-substrate systems, to fully characterize a pellicle which is an unsupported film, to fully characterize a bare substrate, to fully characterize multiple-film-substrate systems, and to design single- and multiple-film-substrate systems. A software program and/or a smart device to be a part of any ellipsometer or ellipsometer system, or to be added to any existing ellipsometer or ellipsometer system, are also provided. All equally apply to reflection and transmission modes of operation.

### CROSS-REFERENCE TO RELATED APPLICATIONS

This non-provisional application claims the benefit of Provisional Application Ser. No. 60/595,687 filed on Jul. 27, 2005 entitled “Complete system identification of film-substrate systems using single-angle-of-incidence ellipsometry: A fast genetic algorithm”.

### FIELD OF INVENTION

The present invention relates to a real-time dynamic complete system characterization of a film-substrate system using a genetic algorithm and ellipsometric measurements; and more particularly, to a real-time dynamic complete system characterization of a film-substrate system using an optimized genetic algorithm for minimum computational effort, and a method to do the same, that uses a physical condition of the system as a fitness function: determine the film optical constant and thickness, and the substrate optical constant. It equally applies to reflection ellipsometry and to transmission ellipsometry.

### BACKGROUND OF THE INVENTION

Ellipsometry is an optical technique that is widely used to characterize film-substrate systems by measuring the two ellipsometric angles psi and del at a certain angle of incidence and a certain wavelength. There are many ellipsometric techniques to do the measurements, and new ones are being developed all the time. A mathematical model developed in the 19^{th} century is used to obtain the optical constants of the film and the substrate in addition to the film thickness. In that model, each measured pair of psi and del provides one complex equation that is equivalent to two real equations. The widespread methods to determine the optical constants and film thickness require a number of real equations equal to the number of unknowns to be determined. Therefore, five real equations are required to determine the optical constants and film thickness since each optical constant is a complex number which has a real and an imaginary component. That requires three pairs of the angles psi and del measured at either three different angles of incidence (Multiple-Angle-Of-Incidence Ellipsometry) or at three different wavelengths (Spectroscopic Ellipsometry.) Several numerical techniques exist today to obtain the required results from the multiple measurements. All take desperately needed time and computational power for dynamic real-time applications. Some require continued intervention by and interaction with a human operator as many of the programs provided by ellipsometer manufacturers today.

Genetic algorithms are heuristic techniques that search a solution space in a manner that resembles natural selective processes where random solutions are generated in that space and evaluated using a fitness function. Those solutions with better fitness functions as defined in the method have a better chance of producing, or participating in producing, new solutions. The worst solutions are rejected and do not participate in the reproduction process. The elite solution, the one with the best fitness function as defined by the method, can get a pass and move directly to the next generation or they can participate in the reproduction process. The reproduction processes of mutation and crossover are determined and carried out in a random way. The reproduction processes to produce new generations of solutions stop when a predetermined exit condition is satisfied which depends on the fitness function.

An important key factor in the performance of the genetic algorithm is the choice of the fitness function itself. In previous work, several applications of genetic algorithms to ellipsometry are reported. In all, the ellipsometric function itself is used as the fitness function. That choice led to very slow performance of the algorithm and to temporary local entrapment where diversity of the populations is lost. It also leads to a surprising illogical result, where using more than one angle of incidence worsened the algorithm performance leading to less accurate results and in other cases to no results at all.

### SUMMARY OF THE INVENTION

It is, therefore, an object of the present invention to provide a real-time dynamic genetic algorithm by properly choosing the fitness function based on a physical condition of the transparent-film absorbing-substrate system, and by providing an optimization method to reduce the number of fitness-function calculations from 20 000 to 69 in some cases and from 80 000 to 181 in other cases. The provided genetic algorithm gives the correct results in each and every case and does not get temporarily trapped at any local or false solutions.

An object of the invention is to measure only one pair of the two ellipsometric angles psi and del using any available ellipsometer at only one angle of incidence and at only one wavelength of operation. The presented genetic algorithm takes the only one measured pair of the ellipsometric angles psi and del along with the only used angle of incidence, the only used wavelength, a starting and ending values for a range of optical constant of the film, and a starting and ending values for a range of optical constant of the substrate as input and it generates a set of random numbers representing the probable solutions for the output parameters required which are the said optical constants of the film and of the substrate. The fitness of each individual of the randomly generated population is then calculated using the given fitness function. The individual with the best fitness as determined by the method is passed to the next generation of individuals without any change. The rest of the population is mutated and crossed over according to a given method and a new generation is derived. The fitness of each individual is calculated and the process is repeated until the solution is obtained according to a given exit condition. The film thickness is then calculated using a provided equation. The number of individuals in a generation is optimized using a given method.

Another object of the invention is to use the provided genetic algorithm to completely identify an absorbing-film absorbing-substrate system where the film thickness and the optical constants of the film and of the substrate are dynamically determined in real time using only one measured pair of the ellipsometric angles psi and del at only one angle of incidence and at only one wavelength of measurement.

Another object of the invention is to use the provided genetic algorithm to completely identify an absorbing-film transparent-substrate system where the film thickness and the optical constants of the film and of the substrate are dynamically determined in real time using only one measured pair of the ellipsometric angles psi and del at only one angle of incidence and at only one wavelength of measurement.

Another object of the invention is to use the provided genetic algorithm to completely identify a transparent-film transparent-substrate system where the film thickness and the optical constants of the film and of the substrate are dynamically determined in real time using only one measured pair of the ellipsometric angles psi and del at only one angle of incidence and at only one wavelength of measurement.

Another object of the invention is to use the provided genetic algorithm to completely identify a bare-substrate system where the optical constant of the substrate is dynamically determined in real time using only one measured pair of the ellipsometric angles psi and del at only one angle of incidence and at only one wavelength of measurement.

Another object of the invention is to use the provided genetic algorithm to completely identify a pellicle where its thickness and its optical constant are dynamically determined in real time using only one measured pair of the ellipsometric angles psi and del at only one angle of incidence and at only one wavelength of measurement.

Another object of the invention is to use the provided genetic algorithm to design 1) an absorbing-film absorbing-substrate system, 2) an absorbing-film transparent substrate system, 3) a transparent-film absorbing-substrate system, 4) a transparent-film transparent-substrate system, 5) a bare-substrate system, and/or 6) a pellicle, where the film thickness and the optical constants of the film and of the substrate, as required, are dynamically determined in real time using only one design pair of the ellipsometric angles psi and del at only one angle of incidence and at only one wavelength of measurement. Or, alternatively use the provided algorithm to determine the angle of incidence and film thickness for a known film-substrate system.

Another object of the present invention is to provide a software computer program to do the same.

Another object of the present invention is to provide a smart device to do the same that can be used with any existing ellipsometer or ellipsometer system, or any ellipsometer or ellipsometer system to be manufactured.

Another objective of the present invention is to do the same in reflection and/or transmission mode of operation.

As the different objects of the present invention that are only presented as preferred embodiments to illustrate the invention are clearly understood by professionals in the field as a result of this patent, it is expected that the other applications of the genetic algorithm and its optimization method will be identified.

### DESCRIPTION OF DRAWINGS

Referring to the drawing detail, FIG. 1 illustrates the film-substrate system. The substrate has an optical constant of N₂with an overlaid film of an optical constant of N₁, both the used wavelength, and a film thickness of d. The electromagnetic wave falls on the surface of the system at an angle of incidence of φ₀, and is reflected at the same angle. When the ellipsometric measurements are made on the incident and reflected beams, it is reflection ellipsometry. When the ellipsometric measurements are made on the incident and transmitted (not shown in figure) waves it is transmission ellipsometry. In practice, we are not interested in the ellipsometric measurements themselves. We are interested in determining the optical constants of the film and the substrate and the film thickness from those measurements; complete system identification. Our genetic algorithm does that in a smart and efficient way. This film-substrate system acts as a polarization device that produces any required polarization changes into the incident waves upon reflection, or transmission.

FIG. 2 is an illustration of a system realization. L is a laser source that produces circularly polarized light at a specific wavelength, P is an optical polarizer that passes a linearly polarized light, S is the sample which in this case is a film-substrate system, D is our Real Time Smart Detector. This smart detector includes a photodetector and our claimed instrument that does the analysis and provides the needed optical constants of the film and the substrate and the film thickness as outputs. This configuration is a Single-Element Rotating-Polarizer ellipsometer configuration. Any ellipsometer configuration can be used with our Real Time Smart Detector.

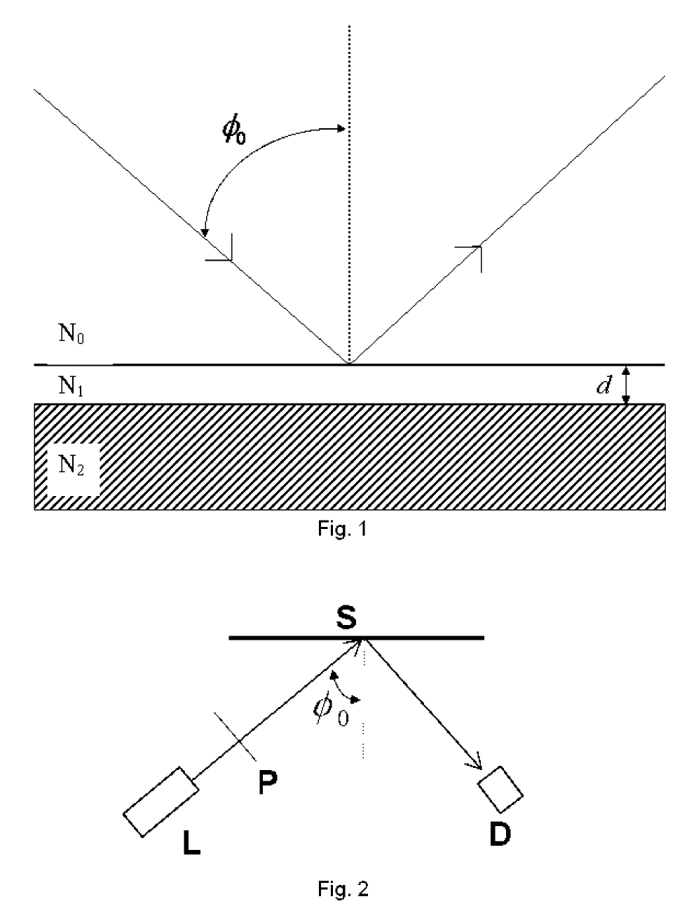

### DETAILED DESCRIPTION OF THE INVENTION

We present a genetic algorithm (GA) that is based on a physical condition of the film-substrate system to completely identify the system. This GA is used to identify the film-substrate system. There are several papers presenting results for the use of genetic algorithms and similar techniques in data inversion of ellipsometry; guided evolutionary simulated annealing, a genetic algorithm-like method, a genetic algorithm, and multi-domain genetic algorithm.

We show that by removing the film thickness from the fitness function, the computational effort to characterize the film is reduced from 20 000 to 69 calculations, a factor of 290 to 1. And that to characterize an absorbing layer is reduced from 80 000 to 180, a factor of 445 to 1. This is a very significant reduction and is very welcome in real-time applications.

1. Singel Angle-of-Incidence Ellipsometry (SAI)

As well recognized in the art, when light is obliquely reflected from an isotropic semi-infinite film-substrate system, the two components of the electric vector of the incident electromagnetic wave parallel (p) and perpendicular (s) to the plane of incidence undergo a magnitude and phase changes upon reflection. Ellipsometry measures the relative change between input and output. This relative change is given by what we call the ellipsometric function ρ;
ρ=tan ψe^{jΔ}, (1)
where ψ and Δ are the two experimentally measured ellipsometric angles.

When light is obliquely reflected from a film-substrate system, the two components of its electric vector parallel (p) and perpendicular (s) to the plane of incidence undergo amplitude and phase changes. The Fresnel reflection-coefficients for the p and s components govern these changes at each interface; ambient-film and film-substrate. For the ambient-film interface we have;

$$\begin{matrix}{r}_{01 p} = \frac{{N}_{1} cos {ϕ}_{0} - {N}_{0} cos {ϕ}_{1}}{{N}_{1} cos {ϕ}_{0} + {N}_{0} cos {ϕ}_{1}} , & ( 2. a ) \\ {r}_{01 s} = \frac{{N}_{0} cos {ϕ}_{0} - {N}_{1} cos {ϕ}_{1}}{{N}_{0} cos {ϕ}_{0} + {N}_{1} cos {ϕ}_{1}} , & ( 2. b )\end{matrix}$$

And, for the film-substrate interface we have;

$$\begin{matrix}{r}_{12 p} = \frac{{N}_{2} cos {ϕ}_{1} - {N}_{1} cos {ϕ}_{2}}{{N}_{2} cos {ϕ}_{1} + {N}_{1} cos {ϕ}_{2}} , & ( 3. a ) \\ {r}_{12 s} = \frac{{N}_{1} cos {ϕ}_{1} - {N}_{2} cos {ϕ}_{2}}{{N}_{1} cos {ϕ}_{1} + {N}_{2} cos {ϕ}_{2}} , & ( 3. b )\end{matrix}$$

where N₀, N₁, and N₂are the refractive indices of the ambient, film, and substrate, respectively. φ₀ is the angle of incidence in the ambient, φ₁ is the angle of refraction into the film, and φ₂ is the angle of refraction into the substrate. The three refractive indices and the three angles of incidence are related by the two independent equations of Snell's law;
N₀ sin φ₀=N₁ sin φ₁=N₂ sin φ₂. (4)

The complex reflection-coefficients for the p- and s-components govern the two-components relative-amplitude and phase changes upon reflection from the film-substrate system; combining the effects of reflections at the two interfaces. For the p-component we have;

$${R}_{p} = \frac{{r}_{01 p} + {r}_{12 p} {ⅇ}^{- j2β}}{1 + {r}_{01 p} {r}_{12 p} {ⅇ}^{- j2β}} . \qquad ( 5 )$$

And for the s-component we have;

$${R}_{s} = \frac{{r}_{01 s} + {r}_{12 s} {ⅇ}^{- j2β}}{1 + {r}_{01 s} {r}_{12 s} {ⅇ}^{- j2β }} . \qquad ( 6 )$$

Where,

$$β = 2 π \frac{d}{λ} {N}_{1} cos {ϕ}_{1} . \qquad ( 7 )$$

And, lambda is the wavelength of the light used.

The ratio between the two complex reflection-coefficients Rₚ and Rₛ governs the reflection of light by the film-substrate system. It was denoted as the ellipsometric function ρ. Therefore, ρ is given by;

$$ρ = \frac{{R}_{p}}{{R}_{s}} , \qquad ( 8 )$$

and from Eqs. (5) and (6);

$$ρ = \frac{{r}_{01 p} + {r}_{12 p} {ⅇ}^{- j2β}}{1 + {r}_{01 p} {r}_{12 p} {ⅇ}^{- j2β}} \frac{1 + {r}_{01 s} {r}_{12 s} {ⅇ}^{- j2β}}{{r}_{01 s} + {r}_{12 s} {ⅇ}^{- j2β}} . \qquad ( 9 )$$

It was recognized that Eqs. (6) and (7) are two bilinear transformations. Therefore, Eqs. (5) and (6) are rewritten as;

$$\begin{matrix}{R}_{p} = \frac{a + bX}{1 + abX} , & ( 10 ) \\ {R}_{s} = \frac{c + dX}{1 + cdX} . & ( 11 )\end{matrix}$$

And, accordingly, Eq. (9) is rewritten as;

$$ρ = \frac{A + BX + {CX}^{2}}{D + EX + {FX}^{2}} . \qquad ( 12 )$$

Where,
(a,b,c,d)=(r₀₁ₚ,r₁₂ₚ,r₀₁ₛ,r12s). (13)
(A,B,C)=(a,b+acd,bcd), (14.a)
(D,E,F)=(c,d+abc,abd). (14.b)
And,

$$X = {ⅇ}^{- j4π \frac{d}{λ} \sqrt{{N}_{1}^{2} - {N}_{0}^{2} {sin}^{2} {ϕ}_{0}}} . \qquad ( 15 )$$

Equation (15) could also be written in the form;

$$X = {ⅇ}^{- j 2 π \frac{d}{{D}_{ϕ 0}}} \qquad ( 16 )$$

where,

$${D}_{{ϕ}_{0}} = \frac{λ}{2 \sqrt{{N}_{1}^{2} - {N}_{0}^{2} {sin}^{2} {ϕ}_{0}}} ; \qquad ( 17 )$$

D_{φ} is the film thickness period, and;
d=dᵣ+mD_{φ}_{₀}, (18.a)
0≦dᵣ<D_{φ}_{₀}. (18.b)
dᵣ is the reduced film thickness, defined by the equivalent smallest film thickness where the system has the same behavior as that at d; same ρ. It is calculated by simply rewriting Eq. (15). Note that dᵣ=D_{φ} does not belong to the angle of incidence-reduced film thickness plane. At this condition, we only have a bare-substrate-equivalent system.

This suggested form of ρ isolates the contribution of the film thickness d to the ρ function in only one term; X. All other coefficients are only functions of the ambient, film, and substrate optical constants N₀, N₁, and N₂, respectively, and not of the film thickness d. This opened the door to many applications in ellipsometry and led to the introduction of several new ellipsometers and to the design methodology of reflection-type optical devices.

The ellipsometric function p is determined experimentally through the measured ellipsometric angles ψ and Δ, and the direct use of Eq. (1).

The general experimental set up is composed of a light source, a polarizer, a compensator, a sample, an alnalyzer, and a detector. In the null operating mode, the compensator azimuth C is adjusted to a pre-specified value, usually +45° and −45° one at a time, to produce a relative phase shift between the p and S component of the incident light beam. It introduces no relative amplitude change. The polarizer azimuth P and the analyzer azimuth A are successively changed to achieve a null output of the experimental system at the detector. The ψ and Δ values are then calculated using very simple equations, depending on the present optical components. In the photometric mode of operation, one of the measuring-system components is rotated, or oscillated, electromagnetically or mechanically to introduce changes into the output signal. This output signal is then Fourier, or otherwise, analyzed to extract the ψ and Δ information, depending on the present optical components. A third mode of operation is to adjust A at four different values, and measure the output light intensity at each. The four measured intensity values along with the corresponding four values of A are used to extract the ψ and Δ information by solving four system-equations algebraically.

As we discussed, there exist a host of techniques to measure the ellipsometric function ρ. Null techniques use the null condition of the output signal. Those are very accurate, but up till now take valuable time to reach the null condition. They are very well suited to characterize static and slowly changing, weak dynamic, film-substrate systems. Photometric ellipsometric techniques that are much faster than the null ones usually rotate, sometimes oscillate, one or more of the experimental-system components and Fourier analyze the output signal to extract the values of ψ and Δ. These ellipsometers are suited for faster, strong dynamic, film-substrate systems. Both categories, null and photometric, when used at different wavelengths of the light beam are then spectroscopic. They take into account the dispersion of the optical properties of the system under measurement. In this case, instead of changing the angle of incidence, the wavelength is changed, to obtain a new ellipsometric measurement of ψ and Δ at a new experimental condition. A smart ellipsometric technique that measures the photodetector output at different values of the analyzer setting, then algebraically solves simultaneous equations is also available to determine ψ and Δ experimentally.

Any of the above mentioned methods could be used to measure one set of values of (ψ,Δ) at any chosen value of the varying experimental parameters; wavelength λ or angle of incidence φ₀. The measured ordered pairs (ψ,Δ) and the chosen values of the experimental parameters (λ,φ₀) are then used to completely identify the film-substrate system; determine the system parameters N₁, N₂, and d.

2. Genetic Algorithm

As well recognized in the art, Genetic algorithms (GA's) are a class of systematic heuristic techniques that simulate biological evolutional systems to find system parameters that minimize a fitness function (FF). The key to the success of harnessing the power of the GA's is in the choice of the FF. Of course, the choice of the GA technique itself plays an important role in the application, but its performance is greatly affected by the choice of the FF. There exist today numerous GA's, but it is very easy for the GA to be trapped into a false solution. Also, there exist several techniques to try to avoid these traps, called local minima of the FF. Actually; they are local traps existing because of the nature of the search methodology of the GA itself.

An important advantage of the GA over curve-fitting techniques, that are widely used today, is that it is very well structured, could be very fast, and that it does not need, and does not depend on, a good starting point. Its starting point is a randomly generated population. Instead, it needs a range to search in for each parameter, which provides a more stable and faster methodology.

The GA used in this study is composed of;

1. Input

Ellipsometric parameters input: ψ and Δ.

GA input 1: Maximum number of generations, population size, crossover rate, mutation rate, and tolerance.

GA input 2: Ranges for required output parameters; N₁, and/or N₂ᵣₑₐₗ and N_{2imag}.

2. Population of the First Generation

Random values within certain boundaries, given ranges, are assigned to N₁, and/or N₂ᵣₑₐₗ and N_{2imag} for the first population. Enough values are generated to fill the population of the first generation.

3. Fitness

The fitness of each member of the population, first or not, is taken as;
fitness=abs(1−|X|).

Since this algorithm uses elitism, it is required to sort the individual with the lowest fitness to the first slot in the population. This is done to prevent this member of the population from going through the reproduction, crossover, and mutation stages later on. This individual gets an automatic pass to the next generation; elitism.

Once sorting has occurred, from then on an individual's fitness is looked at to be
fitness=1/fitness,

to take advantage of a simplified version of the roulette-wheel reproduction method described below.

4. Reproduction

The total fitness of the entire population is obtained by adding up the individual fitnesses.

A percentage is given to each member of the population that indicates an individual's share of the total fitness;
percentage_fitness=fitness/total_fitness.

Each individual's percentage_fitness is added up and a cumulative distribution range is given to that individual.

Reproduction occurs by generating a random value between 0 and 1 and selecting the individual whose range the random value falls into. In other words, the larger an individual's percentage_fitness, the more likely that individual will be reproduced in the next generation.

5. Crossover

Crossover occurs between two parent strings and is based upon the crossover rate. If a randomly generated number between 0 and 1 is less than the crossover rate specified, then crossover occurs. If not, there is no crossover between parent 1 and parent 2.
Point-by-Point Scheme
   If crossover occurs between two individuals, it is then decided how many and which of the three sections (N₁, N₂ᵣₑₐₗ, N_{2imag}), if all are present, will be crossed over. “How many” is decided by generating a random value between 0.5 and 3.5 and then rounding that number off. If “How many”=1 then one random number is generated in the same way as above to decide which part of the string to select (N₁=1, N₂ᵣₑₐₗ=2, N_{2imag}=3). If “How Many”=2 or 3 then the appropriate number of parts of the string are chosen to be crossed over.
   Then the selected section(s) from parent 1 is copied and placed in parent 2 while that section in parent 2 is likewise copied and placed in parent 1.
Arithmetic Scheme
   If crossover occurs between two individuals, once again it is decided how many and which sections will be crossed over.
   Parent 1's section will be replaced by the average of the two values in each section. Parent 2's section will be either 1.5p₁-0.5p₂ or 1.5p₂-0.5p₁. The equation to be used is determined randomly.
   The arithmetic scheme was found to perform better because a higher degree of variation was introduced into the population.
      6. Mutation

Mutation is implemented by generating a new random value for a section in an individual at a certain mutation rate. For example, if the mutation rate is 0.30, a single section in an individual has a 30% chance of being wiped out by a completely new random value within the bounds specified.

The fitnesses are taken of the new individuals and the process starts all over again.

The cycle described above stops when the number of cycles equals the number of generations specified or when the fitness is less than or equal the tolerance, where the tolerance represents how close to zero is the FF at convergence.

7. Fitness Function

As we mentioned above, the choice of the fitness function of the system under consideration is crucial to the success of the GA. For a transparent-film on a an absorbing-substrate (or on a transparent-substrate) film-substrate system, we recognize the fact that, see Eq. (15);
|X|=1. (19)
This physical condition stems from the fact that N₁ is real for a transparent film. Therefore, a very good choice for the FF is;
FF=abs(1−|X|). (20)
Use of this FF rendered very fast film identification and substrate identification, and relatively very fast film and substrate identification.

From Eq. (12) we can write;

$$X = \frac{- ( B - ρ E ) \pm \sqrt{{( B - ρ E )}^{2} - 4 ( C - ρ F ) ( A - ρ D )}}{2 ( C - ρ F )} . \qquad ( 21 )$$

To calculate the FF for a specific set of system parameters (N₀, N₁, d, N₂) knowing the experimental parameters (λ,φ₀) and the measured parameters(ψ,Δ);

1. Use Eq. (1) to calculate the ellipsometric function ρ.

2. Use Eq. (21) to calculate X. Note that it does not depend on d.

3. Use Eq. (20) to calculate the FF.

8. Population Size (PS)

Population size (PS) plays a role in the speed of conversion of the GA. In general, there is a relation between the PS and the speed of conversion. The larger the PS, the faster the speed of conversion. This is true up to a limit, at which any increase in the PS will not lead to faster speeds of conversion. Therefore, the proper choice of the population size would lead to fast conversions.

9. Parameter Range

Each parameter needs to be assigned a range for the GA to search through. For a known film-substrate system, a reasonable range for each of the parameters to be identified is easily determined to include any differences between known and actual physical values of the system under consideration. Also, the chosen range should account for the expected experimental errors.

10. Mutation Rate

The mutation rate plays a role in the speed of convergence of the GA. A tuning of the mutation rate is easily possible for a specific film-substrate system. Currently, trial and error is the method used for tuning. An artificial intelligence method is being developed by the authors for that purpose.

11. Crossover Rate

The crossover rate, as the mutation rate, plays a role in the speed of convergence of the GA. Also, a tuning of the crossover rate is easily done for a specific film-substrate system by trial and error. In addition, an artificial intelligence method is being developed by the authors to achieve that goal.

12. Optimum Population Size (OPS)

For any PS, there is a corresponding Number of Generations (NG) at which the used GA converges. It depends on the FF used and the GA itself. We define the Optimum Population Size (OPS) as the population size at which the GA converges with the minimum computational effort; minimum number of calculations. A search for the OPS of the system under consideration is carried out.

3. Controlled Parameters

In this section, we discuss the tolerance and its choice, and the accuracy of the genetic algorithm and how to improve it.

A. Tolerance

The tolerance is defined as the minimum value of the fitness function that is considered zero, at which the output of the GA it considered to be a solution. As the tolerance is reduced, the GA approaches the correct solution, with an increased number of calculations. It is found that a tolerance of 10⁻² leads to the correct solution in some cases, as in the case of one-parameter problems such as N1. As the number of parameters to be determined increases, the tolerance needs to be decreased, to maintain the same accuracy of determination. In the general case of determining N1, N₂ᵣₑₐₗ, and N_{2imag}, the tolerance of 10⁻⁵ is used to obtain the correct solutions of the three parameters. This comes with a price of an increased number of calculations.

B. Accuracy

The tolerance has a direct effect on the accuracy of the obtained results. Accordingly, the largest value of Tolerance is to be chosen that will give the accurate value of parameters, with the least computational effort.

4. Other Uses of the GA

In addition to the use of the GA in reflection ellipsometry as discussed above in details, it could be used in other applications. For example;

A. Transmission Ellipsometry

The same GA with minor modifications to replace the reflection ellipsometry equation, Eq. (9), with the proper transmission ellipsometry equation works to completely identify the transparent-film-absorbing-substrate system.

B. Multifilm-substrate Systems

The same GA with minor modifications to replace the transparent-film-absorbing-substrate reflection or transmission ellipsometry equation with the proper multifilm-substrate equation works to completely identify the system.

C. Design of Transmission and Reflection Thin-Film Polarization Devices

The same GA with minor modifications works to determine the design parameters of a transmission or reflection thin-film polarization device; film thickness and angle of incidence for certain system materials, or system materials for certain film thickness and angle of incidence, or any required combination thereof. Examples of polarization devices are, but not limited to, retarders, polarizers, linear partial polarizers, halfwave retarders plus linear partial polarizers, etc.

D. Absorbing-Film/Multifilm-Absorbing-Substrate Systems

Use of the GA in items A, B, and C could be applied to the case of absorbing-film/multifilm-absorbing-substrate systems with the proper modification.

E. Special Cases

The cases of transparent-film-transparent-substrate system, bare-substrate systems, film identification, and substrate identification are all special cases of the general respective cases discussed above, and the GA applies equally to all of them.

What is claimed is:

1. A GA method to completely identify, i. e. totally characterize, film-substrate systems based on a physical condition of the film-substrate system:
The first GA completely identifies transparent-film-absorbing-substrate systems using single-angle-of-incidence ellipsometry utilizing a unique fitness function based on the value of X as explained (further description is available in: A. R. M. Zaghloul and Y. A. Zaghloul, “complete system identification of transparent-film-absorbing-substrate systems using single-angle-of-incidence ellipsometry: A fast genetic algorithm,” submitted to Applied Optics, 2005; A. R. M. Zaghloul and Y. A. Zaghloul, “A fast genetic algorithm to fully characterize transparent-film-absorbing-substrate systems using ellipsometry” SPIE annual meeting Aug. 1, 2005, San Diego, Calif., paper 5878-15).

2. A computer program for completely identifying, film-substrate systems and perform ellipsometric analysis based on a physical condition of the film-substrate system:
The first Program completely identifies transparent-film-absorbing-substrate systems using single-angle-of-incidence ellipsometry utilizing a unique fitness function based on the value of X (see further description in materials listed above in claim 1).

3. A real-time instrument that can be attached to ellipsometers, for completely identifying film-substrate systems and perform ellipsometric analysis based on a physical condition of the film-substrate system:
The first device completely identifies a transparent-film-absorbing-substrate systems using single-angle-of-incidence ellipsometry utilizing a unique fitness function based on the value of X (see further description in materials listed above in claim 1).

4. Claim 1, 2 and 3 applied to: Reflection and Transmission modes of Ellipsometry, of Multifilm-substrate systems, of Design of Thin-Film Polarization Devices, of Absorbing-Film/Multifilm-Absorbing-Substrate Systems, and of special cases as explained in 4.A, 4.B, 4.C, 4.D, and 4.E respectively.
